(19) United States
(12) Patent Application Publication
(10) Pub. No.: US 2007/0136060 A1
(43) Pub. Date: Jun. 14, 2007

(54) Recognizing entries in lexical lists

(76) Inventors: Marcus Hennecke, Graz (AT); Volker Schless, Blaustein (DE)

Correspondence Address: BRINKS HOFER GILSON & LIONE, P.O. BOX 10395, CHICAGO, IL, 60610, US

(21) Appl. No.: 11/454,612

(22) Filed: Jun. 15, 2006

(30) Foreign Application Priority Data
Jun. 17, 2005 (EP) EP 05 013 168.9

(51) Int. Cl. G10L 15/04

(52) U.S. Cl. 704/251

(57) ABSTRACT

A system recognizes speech using lexical lists. The lexical list may have entries that correspond to words or commands. The system includes an interface for receiving voiced speech and a recognition unit that generates string hypotheses based on the voiced speech. The recognition unit assigns a score to each of the string hypotheses. One of the string hypotheses is compared with an entry in the lexical list by a comparison unit. An assignment unit may then assign one of the string hypotheses to an entry in the lexical list.

### PRIORITY CLAIM

This application claims the benefit of priority from European Application No. 05013168.9, filed Jun. 17, 2005, which is incorporated herein by reference.

### BACKGROUND

1. Technical Field

The invention relates to recognizing speech, in particular, to a system that recognizes speech from lexical lists.

2. Related Art

Some speech recognition systems use variants of phonemes to represent a linguistic word. The variants, known as allophones, may be represented by models that include a sequence of states having a defined transition probability. To recognize a spoken word, the speech recognition system may compute a likely sequence of states through these models. Some speech recognitions systems may infer a correct spelling of a word or sentence. The inference may correspond to acoustic signals that correspond to a finite vocabulary.

A collection of stored words may store too many words for practical applications, especially when the collection is used to access a telephone directory or to initiate a call using voice commands. In these systems, search processes may take an unacceptably long time. In some systems, the recognizing components may not correctly identify words. Recognition may be difficult when lexical lists also include homophones. Some systems mitigate these problems by rank ordering the recognized words and creating N-best lists.

While a comparison between a verbal utterance and entries in a list may result in a ranking, some systems do not provide an indication of reliability. When an unrecognized word is spoken, some systems also unintentionally associate these words with a recognized list.

### SUMMARY

A system recognizes speech using lexical lists stored in a memory. The system includes an interface that detects speech signals. A processor digitizes the detected speech signals. A recognition unit in communication with the processor generates two or more string hypotheses that correspond to the speech signal and assigns a score to each of the string hypotheses. A comparison unit compares one of the string hypotheses with an entry in the lexical list based on a score. An assignment assigns a string hypothesis to the entry in the lexical list based on a comparison.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a flowchart that recognizes speech from a lexical list.

FIG. 2 is a flowchart that determines vectors of a digitized speech signal.

FIG. 3 is a flowchart that recognizes string hypotheses for a digitized speech signal

FIG. 4 is a flowchart ranking a scored list of string hypotheses.

FIG. 5 is a flowchart comparing a ranked list of scored string hypotheses to entries in a lexical list.

FIG. 6 is a flowchart assigning a string hypothesis in a ranked list of scored string hypotheses to an entry in a lexical list.

FIG. 7 is an alternative flowchart that assigns a string hypothesis in a ranked list of scored string hypotheses to an entry in a lexical list.

FIG. 8 is flowchart illustrating recognition of speech using a lexical list.

FIG. 9 is a block diagram of a system that recognizes speech using a lexical list.

FIG. 10 is a block diagram of an alternative system that recognizes speech using lexical lists.

FIG. 11 is a block diagram of the speech recognizing system interfaced to a navigation system.

### DETAILED DESCRIPTION

Due to dramatic improvements in speech recognition technology, high performance speech analysis, recognition algorithms and speech dialog systems are available. Present day speech input capabilities include activities such as voice dialing, call routing, and document preparation. A speech dialog system may be used in various environments. An example of such an environment is a vehicle, where the speech dialog system allows the user to control different devices such as a wireless phone, a car radio, a navigation system or other devices.

Some speech recognition systems are speaker dependent requiring a user to provide samples of his or her speech. Other systems may be speaker independent and may not require the user to provide samples of his or her speech. Where a speech recognition system recognizes words, the recognized words may represent commands to the system and may serve as an input to further linguistic processing. The term “words” may refer to linguistic words, but may also refer to subunits of words, such as syllables, phonemes, allophones, or combinations. A sentence may include any sequence of words, including a sequence of linguistic words.

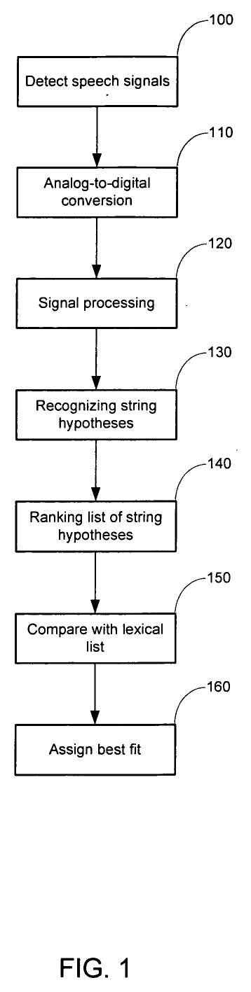

FIG. 1 illustrates a method that recognizes speech using lexical lists, such as long lexical lists. In FIG. 1, speech signals are detected (Block 100). The speech signals may be detected by an input device that converts sound into an input signal, such as microphone or an array of microphones. The speech signals may include a word or a phoneme. The speech signals may be detected as isolated words or as continuous speech.

When the speech signals are detected (Block 100), the detected speech waveforms may be sampled and processed to generate a representation of the speech signals. The verbal utterance detected by the input device may be converted to analog signals and then digitized using an analog-to-digital converter (Block 10). The analog-to-digital converter may be an electronic circuit that converts continuous analog signals to discrete signals. In one system, the analog speech signals may be converted into digital speech signals using pulse code modulation.

Digitizing speech signals may include sampling the analog signals at a rate between about 6.6 kHz and about 20 kHz. Digitizing the speech signals may also include dividing the speech signals into frames at a fixed rate, such as about once every 10-20 ms. Frames may include about 300 samples of about 20 ms duration each. These measurements may be used to search for the most likely word candidate, using the constraints imposed by various models, such as acoustical models, lexical models, language models, or combinations of other similar models.

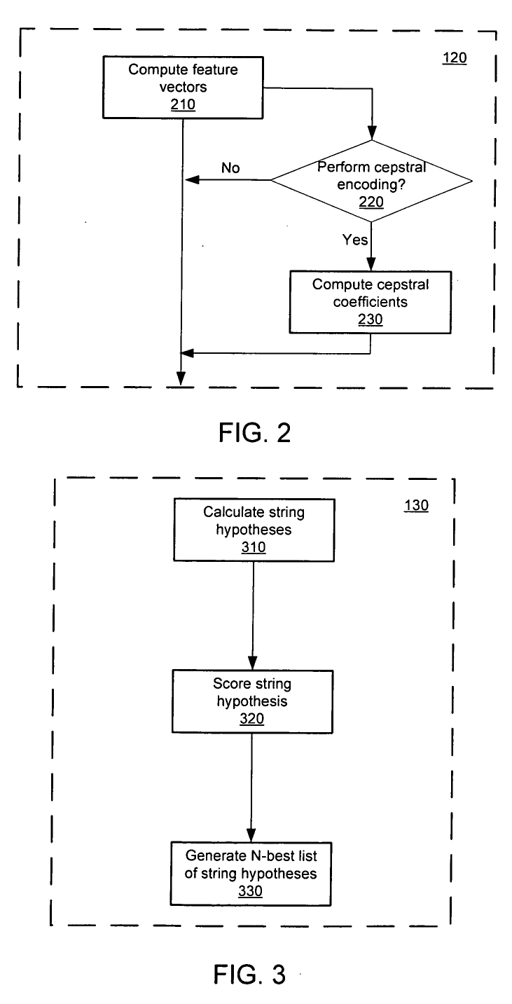

After converting the analog speech signals into digital speech signals (Block 110), signal processing may be performed on the digital speech signals (Block 120). In FIG. 2, the signal processing may derive a representation of the speech waveform as a sequence of feature vectors containing feature parameters (Block 210). The feature vectors may be derived from the short-term power spectrum of the detected speech signal. The vectors may have about 10 to about 20 feature parameters and the vectors may be computed for every or nearly every frame. The feature parameters may comprise the power of about 20 discrete frequencies that may be relevant to the identification of the string representation of the detected speech signal. The feature parameters may be used for estimating the probability that the portion of analyzed waveform corresponds to a particular detected phonetic event. The feature parameters may provide information that helps distinguish different phonemes, such as the frequencies and amplitudes of the detected speech signals.

As a feature vector may include a cepstral vector, a determination may be made during signal processing as to whether to perform cepstral encoding (Block 220). If the feature vector is a cepstral vector, then the signal processing may include cepstral encoding to compute the cepstral coefficients (Block 230). The cepstral coefficients may be used to represent the cepstrum, which separates the glottal frequency from the vocal tract resonance of the digitized speech signals. Cepstral encoding may include an inverse Fourier transform of the logarithm of the Fourier transformed detected speech signals digitized by the analog-to-digital conversion (Block 110). Other encoding techniques, such as linear prediction coding, may also be used in addition, or alternatively to, cepstral encoding.

When the cepstral vectors are derived, the speech recognition process may generate an N-best list of string hypotheses (Block 130) as shown in FIG. 3. The recognition process may calculate an individual string hypothesis (Block 310). The individual string hypothesis may be evaluated by some measure according to one or more predetermined criteria with respect to the probability that the hypothesis represents the detected speech signals. The evaluation of the individual string hypotheses may determine the score of the individual string hypothesis (Block 320). The generated string hypotheses may comprise a set or sequence ordered to a confidence measure of the individual hypotheses. The process of generating an N-best list of string hypotheses may yield alternative suggestions for a string representation of the detected speech signals. The probability to correctly identify the detected speech signals may differ between several hypotheses. After generating the N-best list of string hypotheses, an N-best search may be performed.

The scoring of the string hypotheses may include scoring individual phonemes or characters (Block 320). An entire linguistic word hypotheses of characters may also be scored. The scoring of these linguistic words may be based on scores of the characters and phonemes or allophones that comprise the word. Scoring may be based on the acoustic features of phonemes, Hidden Markov Model probabilities, grammar models, or a combination of other models.

In one method, acoustic features of phonemes may be used to determine the score of a string hypothesis. For example, the letter “S” may have a temporal duration of more than 50 ms and may exhibit frequencies above about 44 kHz. These characteristics may be used with statistical classification methods. In another method, the score may represent distance measures indicating how far from or close to a generated vector of an associated word hypothesis is to a specified phoneme. In recognizing sentences, grammar models, including syntactic and semantic information, may be used in scoring individual string hypotheses representing linguistic words.

Different models may be used that generate the N-best list of string hypotheses (Block 330). For example, a Hidden Markov Model (HMM) may be used to generate the N-best list of string hypotheses. An HMM comprises a doubly stochastic model, in which the generation of the underlying phoneme string and the frame-by-frame surface acoustic realizations are both represented probabilistically as Markov processes. During the search process, speech segments may be identified. An alternate approach may be to identify speech segments, then classify the segments and use the segment scores to recognize words.

An alternative to using HMM may be to use text-independent recognition methods based on vector quantization (VQ). Using vector quantization, VQ codebooks having a limited number of representative feature vectors may be used to characterize speaker-specific features. A speaker-specific codebook may be generated by clustering the training feature vectors of each speaker. In the recognition stage, an input utterance may be vector-quantized using the codebook of each reference speaker. The VQ distortion accumulated over the entire input utterance may then be used to make the recognition decision.

In the training phase, reference templates may be generated and identification thresholds may be computed for different phonetic categories. In the identification phase, after the phonetic categorization, a comparison with a reference template for different categories may provide a score for each category. A final or accumulated score may be a weighted linear combination of scores from each category.

The recognizing process (Block 130) of the cepstral vectors provides a scored listing of word or string hypotheses (Block 140). Each recognized word may be evaluated or scored through a probability or some distance measure to each word. Scores may be encoded using characters, numbers, or combinations thereof. For example, if a speech signal is recognized as the letter “F” with a high probability, the score for the letter “S” may be a lower score where recognition of the letter “F” was carried out with a lower reliability.

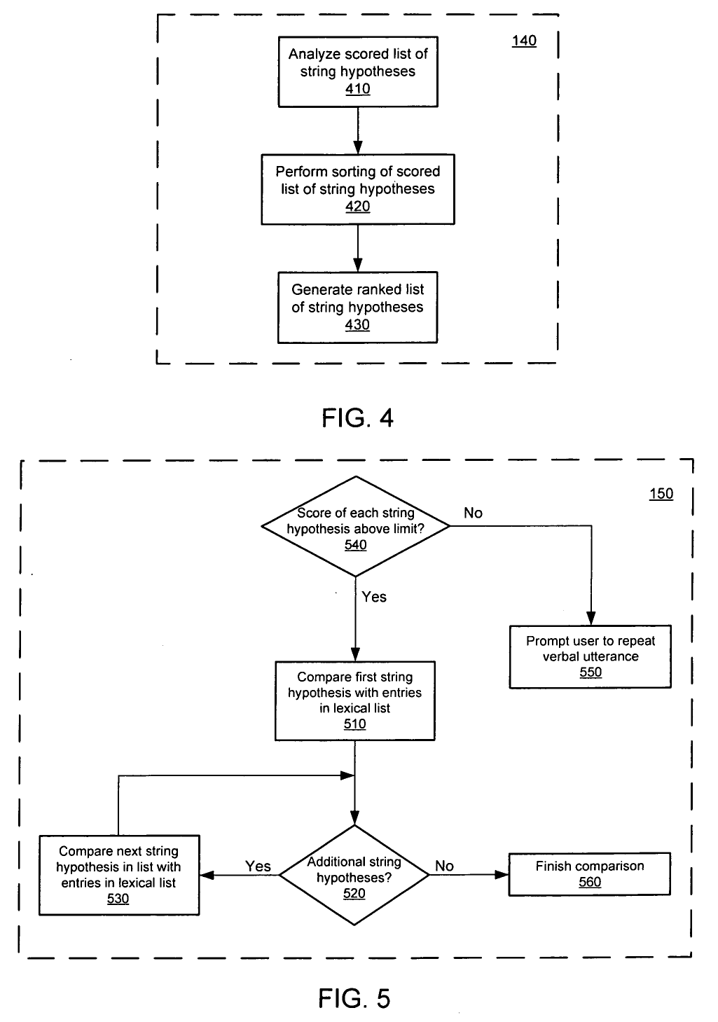

After scoring the string hypotheses, the method may rank order the string hypotheses (Block 140). As shown in FIG. 4, the ranking process may analyze the scored list of string hypotheses according to a predetermined sorting algorithm (Block 410). After analyzing the scored list of string hypotheses, the sorting algorithm may sort the string hypotheses based on the scores of the individual string hypotheses (Block 420). Sorts of the ranking process may include a bubble sort, a quicksort, a merge sort, a heapsort, or a combination of other similar sorts. After the scored list of hypotheses has been sorted, the ranking process generates a ranked and sorted list of the string hypotheses (Block 430). While the scores may not provide an indication of whether a hypothesis is correct, it may indicate a preferable hypothesis over the other hypotheses. However, subsequent iterations may allow for a better estimate of the probability of a correct hypothesis encoded by the score.

Based on the scored entries of the ranked list of word hypotheses (Block 140) during the recognizing process (Block 130), comparison with the entries of a lexical list is performed (Block 150). As shown in FIG. 5, the comparison may be performed for the recognized word hypothesis with the best score (Block 510). The comparison may be carried out for each element of the scored list of string hypotheses to improve the probability that the utterance is recognized correctly (Block 520/Block 530). If all string hypotheses have scores below a predetermined limit, no comparison may be performed, but a prompt may be made to the speaker to repeat the initial verbal utterance (Block 540/Block 550). This method may save time and increase general acceptance of the speech recognition system by the user. After the comparison process has finished with the ranked list of string hypotheses (Block 560), the comparison process may proceed to the assignment process (Block 160).

As an example, it may be possible to identify the verbal utterance of a consonant, such as the letter “S,” without any or minimal ambiguities. The recognizing result for this consonant may be highly reliable in terms of the employed scoring method. In contrast, a different generated hypothesis, such as the letter “M”, may exhibit a poor scoring. To facilitate and improve the comparison between the recognizing results and the entries in the lexical list, any comparison between the hypothesis letter “M” and the lexical list may be omitted. If a linguistic word is to be identified, words with a leading letter “S” may first be compared to the string hypothesis.

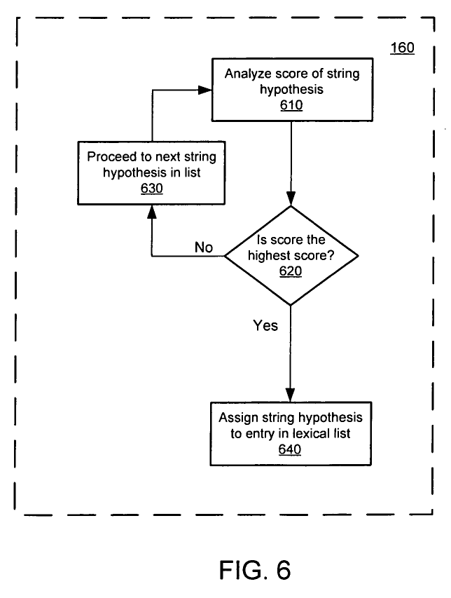

After comparing the scored list with the lexical list (Block 150), the respective generated string hypothesis of the scored listing may be assigned to the entry of the long lexical list that most probably represents the detected speech signals (Block 160). The assignment process may determine which entry of the lexical list most probably corresponds to the detected speech signal. The assignment process may be based on the scores of the string hypotheses. As shown in FIG. 6, the assignment process may first analyze the score given to a string hypothesis of the scored list of string hypotheses (Block 610). The assignment process may then determine whether the score of the analyzed string hypothesis is the highest score of the scored list of string hypotheses (Block 620). If the assignment process determines that the score of the analyzed string hypothesis is not the highest score, the assignment process may then proceed to the next string hypothesis in the list of string hypotheses (Block 630). If the assignment process determines that the analyzed string hypothesis has the highest score of the string hypotheses, the assignment process may then assign the analyzed string hypothesis to the entry of the lexical list corresponding to the detected speech signal (Block 640). Hence, word hypotheses with a high score may be assigned first to the respective entry of the lexical list instead of hypotheses with a low score. By assigning a word hypothesis to an entry in the lexical list based on the score of the hypothesis, there may be an increased probability in identifying the correct string representation for the detected speech signal.

As an example, suppose that the score of a consonant, such as the letter “S,” is very high. A high score may indicate that the recognizing result can be regarded as reliable. As in this example, since the letter “S” has a high score, an assignment to an entry in the lexical list representing the letter “S” may be preferred over an assignment to a different consonant have similar acoustical aspects, such as the letter “F.”

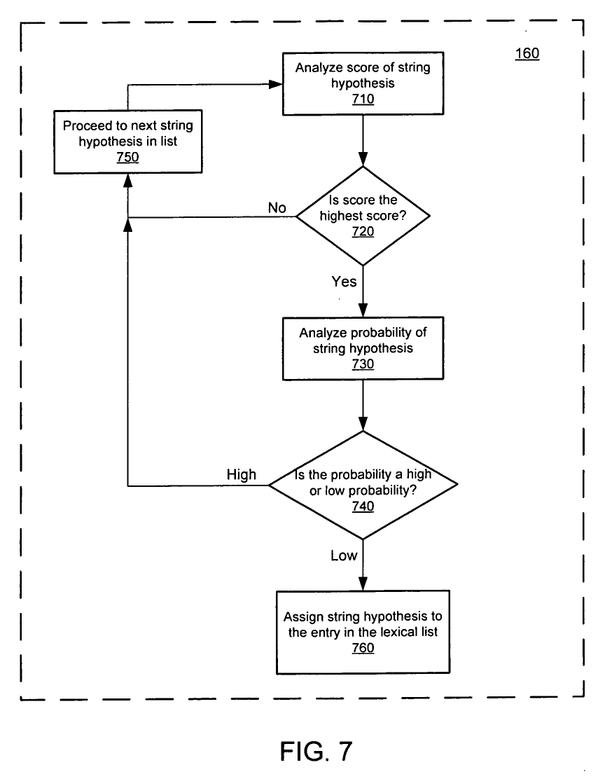

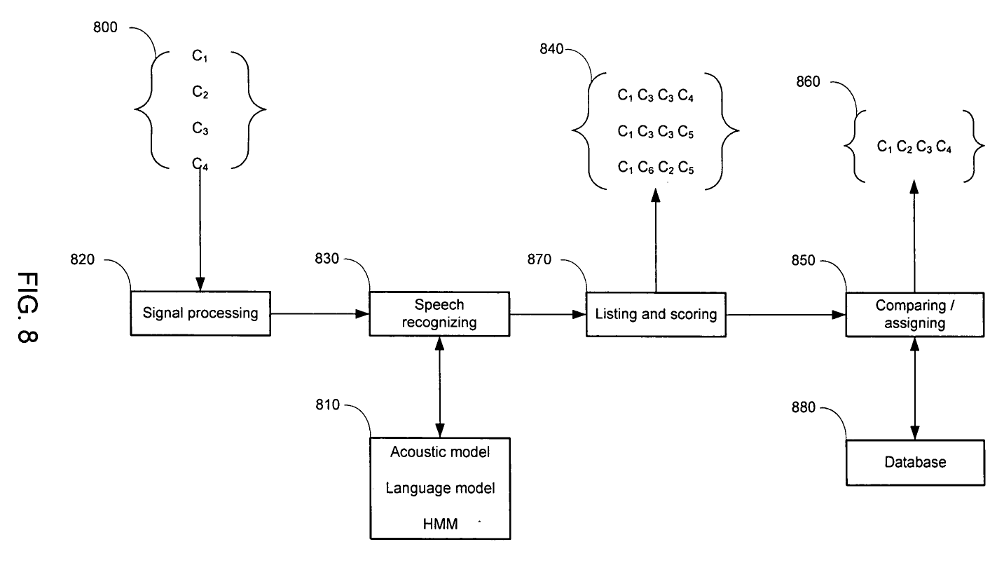

FIG. 7 is another assignment process (Block 160) where assignment of the string hypothesis to an entry in the lexical list may be based on a predetermined probability of mistaking at least one of the generated string hypothesis with another string hypothesis in addition to retaining the score of the string hypothesis. As in FIG. 6, the assignment process shown in FIG. 7 may first analyze the score of the string hypothesis (Block 710), and then determine whether the score of the analyzed string hypothesis is the highest score (Block 720). If the assignment process determines that the analyzed string hypothesis has the highest score, the assignment process may then analyze the probability of mistaking the string hypothesis with another string hypothesis (Block 730). The assignment process may then determine whether the probability of the analyzed string hypothesis with another string hypothesis is a high or low probability (Block 740). If the assignment process determines that there is a high probability of mistaking the analyzed string hypothesis with another string hypothesis, the assignment process may proceed to the next string hypothesis in the list of string hypotheses (Block 750). If the assignment process determines that there is a low probability of mistaking the analyzed string hypothesis with another string hypothesis, the assignment process may then proceed to assign the analyzed string hypothesis to the entry in the lexical list (Block 760).

In an alternative arrangement, the assignment process may give priority to the score rather than the probability of mistaking a string hypothesis with another string hypothesis. However, utilization of two different criteria, such as the string hypothesis' score and the probability of mistaking one hypothesis for another, may further improve the reliability method for speech recognition. The probability of mistaking one string hypothesis for another, such as mistaking the letter “F” for the letter “N,” may be known a priori or may be determined by testing.

The comparing (Block 150) and/or assigning (Block 160) of FIG. 1 may also be performed based on a substring of the string hypothesis. An analysis between a substring of a word hypothesis and an entry in a pre-stored list may be sufficient to quickly find a correct data representation of the detected speech signals.

The method of FIG. 1 may be encoded in a computer readable medium such as a memory, programmed within a device such as one or more integrated circuits, one or more processors or may be processed by a controller or a computer. If the method is performed by software, the software may reside in a memory resident to or interfaced to a storage device, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source, such as an analog audio, video signal, or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

FIG. 8 illustrates a method of recognizing entries from a lexical list. A speaker voices a verbal utterance. The speaker may have trained the speech recognition system or the speech recognition system may be speaker independent. In this example, the speaker utters four different characters or phonemes (C₁, C₂, C₃, C₄) (800) that may comprise a particular linguistic word. The speech signals may be detected, digitized and processed (Block 820) to generate a sequence of feature vectors. The feature vectors may have a variety of feature parameters such as frequencies, amplitudes, and energy levels per frequency range. Other feature parameters may also be possible.

In one example, the recognition operation (Block 830) is performed on the feature vectors employing a HMM that uses an acoustic model and a language model (810). According to the acoustic model, a sequence of acoustic parameters may be seen as a concatenation of elementary processes described by the HMM. The probability of a sequence of words, such as phonemes, may then be computed by a language model.

Different text-dependent methods may also be used. Such methods may be based on template-matching techniques. Using a template-matching technique, the verbal utterance may be represented by a sequence of feature vectors, such as short-term spectral feature vectors. The time axes of the input utterance and each reference template or reference model of the registered speakers may be aligned using a dynamic time warping (DTW) algorithm. The time axes of the input utterance may be accumulated from the beginning of the input utterance to the end of the input utterance. The degree of similarity between the time axes may then be calculated. However, as an HMM may model statistical variations in spectral features, HMM-based methods may be used as extensions of the DTW-based methods.

A set of string hypotheses may be generated where the hypotheses are listed and scored according to the results of the employed HMM (Block 870). As shown in FIG. 8, three word hypotheses, comprised of four hypotheses for characters or phonemes each, are found (840) as possible data representations of the input speech signals comprising the characters or phonemes (C₁, C₂, C₃, C₄). In this example, the C₁ is recognized with a high score, which may indicate that the recognizing result is reliable. That C₁ is recognized with a high score may be taken into account when comparing the hypotheses with the entries of a lexical list stored in a database (880). The high score may also be taken into account for assigning a hypothesis to an entry in the database, whether the assignment is for a hypothesis of an individual character or for the word consisting of four characters as shown in FIG. 8.

Further shown in FIG. 8, is that the second character C₂ is recognized as C₃ with a high score and as C₆ with a lower score. The third character is correctly identified as C₃ with a high score and as C₂ with a lower score. The fourth character is correctly identified as C₄ with a high score and as C₅ with a lower score. The word hypotheses (840) may comprise a rank ordered list for the words comprising four characters each. The rank ordering may also be for the recognition of individual characters.

The entries of the word hypotheses (840) may then be compared (Block 850) with entries in a database (880) that includes a lexical list. The lexical list may include individual characters, phonemes, linguistic words, or combinations thereof. In one example, each hypothesis for a character is assigned (Block 850) to a character in the lexical list (880). In another example, the string hypothesis consisting of the four characters is assigned to a four-character entry, such as a linguistic word comprising four characters, in the lexical list. If a word consisting of (C₁, C₃, C₃, C₄), or (C₁, C₃, C₃, C₅), or (C₁, C₆, C₂, C₅) is not present in the lexicon but one entry is given by (C₁, C₂, C₃ C₄), it may be possible to assign the correct sequence (C₁, C₂, C₃, C₄) to the linguistic word hypothesis (C₁, C₃, C₃, C₄). As shown in FIG. 8, it may thus be possible to obtain a data representation (860) that represents a correct identification of the verbal utterance (800).

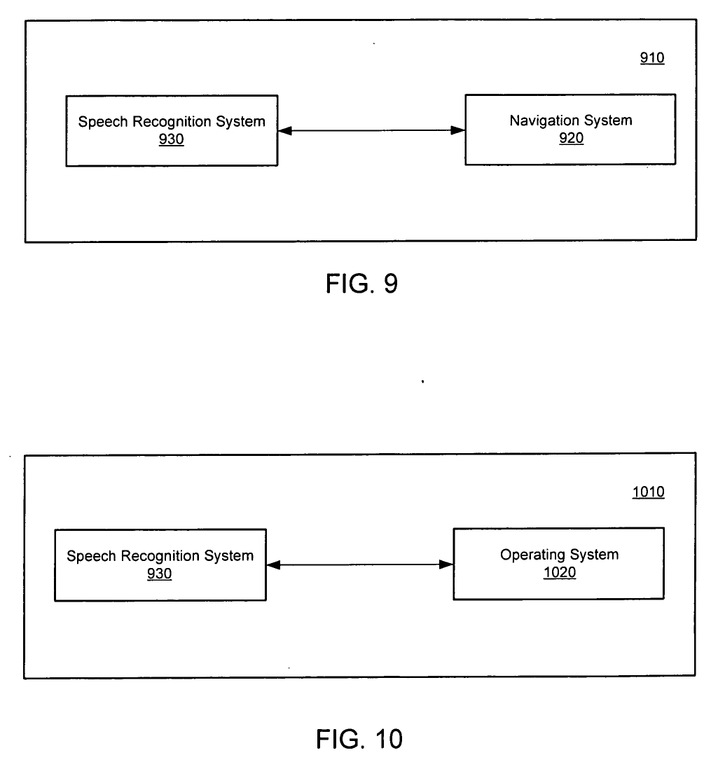

FIG. 9 is a block diagram of a system that recognizes speech using lexical lists. In FIG. 9, the system may comprise a navigation system (920) coupled to a device or structure for transporting persons or things, such as a vehicle (910). A user may interact with the navigation system (920) directly, such as through a visual input, audio input, or other interface. The user may also interact with the navigation system (920) indirectly, such as through peripheral input devices, such as through a headset. Other systems using the methods described may include embedded telephone systems, a directory assistance system that determines the telephone number that may have a corresponding spoken word, or an automatic retrieval system that may request train and flight schedules.

FIG. 10 is a block diagram of another system that recognizes speech using lexical lists. In FIG. 10, the system comprises an operating system (1020) residing on a computer (1010). A user may interact with the operating system (1020) using a tactile input device, such as a keyboard, mouse, or other similar input device. The user may also interact with the operating system (1020) using an audio input device, such as microphone, headset, or other device. As shown in FIG. 10, the speech recognition system (930) may reside on the same computer (1010) as the operating system (1020). Alternatively, the speech recognition system (930) may reside on a remote computer. The speech recognition system (930) recognizes words spoken by the user toward the computer (1010). Using the speech recognition (930) shown in FIG. 10, a user may be able to control hardware or software employing the operating system (1020).

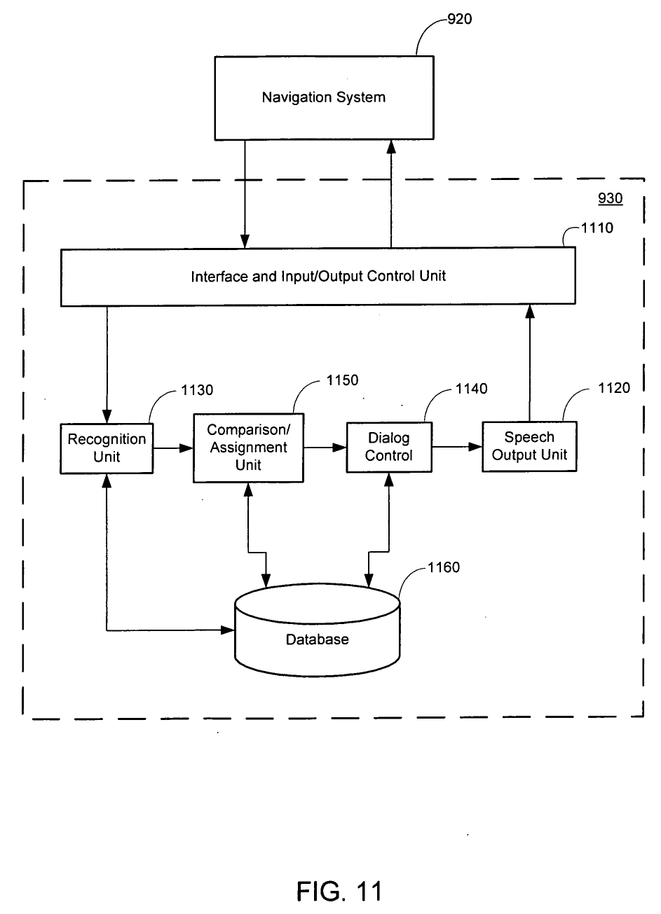

FIG. 11 is a block diagram of the speech recognition system (930) in communication with the navigation system (920) shown in FIG. 9. An interface and input/output control unit (1110) may be coupled to the navigation system (920). The link between may comprise a wired link, wireless link, or a link using a combination.

An interface and input/output control unit (1110) may control the vehicle navigation system (920) through voice commands or other vocalized information. The interface and input/output control unit (1110) may be implemented in software that enables the vehicle navigation system (920) to interact with the other components of the speech recognition system (930), such as the recognition unit (1130) or a comparison and assignment (1150). The interface and input/output control unit (1110) may include an audio input device, such as a microphone or other devices for detecting audio signals, and may further include a pre-processor for processing the detected speech signals through an audio input device. A user may interact with the vehicle navigation system (920) to show the user a route to a destination by speaking the name of the destination. For example, a user may ask for directions to Stuttgart, in Baden-Württemberg, Germany, such as by speaking the word “Stuttgart.” The speech signals representing “Stuttgart” may then be detected and subsequently processed as described in FIGS. 1 through 8.

A recognition unit (1130) may be coupled with the interface and input/output control unit (1110). The recognition unit (1130) may comprise hardware or software. The interface and input/output control unit (1110) may transmit the detected speech signals from the user to the recognition unit (1130). The recognition unit (1110) may then recognize string hypotheses from the detected speech signals. The recognition unit (1130) may be coupled with and supported by a database (1160). If the speaker has trained the system for speech recognition, in addition to controlling the navigation system by speech, driver identification may also be performed.

After recognizing the string hypotheses from the detected speech signals, the recognition unit (1130) may score the string hypotheses. The recognition unit (1130) may provide an ordered list of the scored string hypotheses. These hypotheses may be transmitted to a comparison and assignment (1150). The comparison and assignment (1150) may comprise hardware or software. The comparison and assignment (1150) may comprise a separate comparison unit and a separate assigning unit. For example, the recognition unit (1130) may transmit a set of three string hypotheses, such as “Frukfart,” “Dortmart,” and “Sdotdhord,” to the comparison and assignment (1150). In this example the first character “S” may be regarded as being recognized with a high reliability denoted by a high score.

The comparison and assignment (1150) may then compare the three string hypotheses with entries of a lexical list stored in a management system that stores information, such as a database (1160). The database (1160) may be in communication with the comparison and assignment (1150). In the example described above, since the letter “S” is denoted with a high score, a comparison operation may determine that there is a high probability that the target word starts with the letter “S”. If the score is low, the comparison and assignment unit (1150) may analyze words starting with the letter “F.” It may be known that the recognition unit (1130) might mistake the letter “F” for the letter “S” based on a predetermined probability.

In the current example, the name of the city “Frankfurt” is not regarded as the target word by the comparison and assignment (1150). Rather the correct word “Stuttgart” will be assigned to the most reliable string hypotheses. Alternatively, a successful comparison may be based on a comparison of a substring. A comparison based on a substring may be performed exclusively, alternatively or additionally to comparison on the basis of the entire word hypothesis.

Based on the output from the comparison and assignment (1150), the dialog control (1140) may prompt a request for confirmation, such as “Destination is Stuttgart?,” using a speech output unit (1120). Alternatively, the dialog control may prompt a request for confirmation through a visual output device, such as a liquid crystal display device (not shown) coupled with the dialog control (1140). It may be possible that dialog control (1140) presents visual information and an audio prompt simultaneously. The dialog control (1140) controls the speech output unit (1120) by using the database (1160), which provides the phonetic or textual information about the word(s) and/or sentence(s) outputted a user. The adequate word(s) and/or sentence(s) may depend on the input speech signal provided in a processed form to the recognition unit (1130). In response to the prompt provided by the dialog control (1140), the dialog control (1140) may give navigation instructions by voice via speech output unit (1120) or via a visual output device to guide the driver to the destination “Stuttgart”.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

I claim:

1. A method of recognizing speech, comprising:
detecting a verbal utterance;
converting the verbal utterance into a speech signal;
digitizing the speech signal;
generating at least two string hypotheses corresponding to the speech signal;
assigning a score to each of the at least two string hypotheses; and
comparing at least one of the string hypotheses with an entry in the lexical list based on the score of the at least one string hypothesis.

2. The method according to claim 1, further comprising assigning the at least one string hypothesis to the entry in the lexical list to obtain a data representation of the detected speech signal, where assigning is based on comparing the at least one string hypothesis with the entry in the lexical list, and the score of the at least one of the string hypothesis.

3. The method according to claim 2, where comparing the at least one string hypothesis with the entry in the lexical list is based on a substring of the at least one string hypothesis.

4. The method according to claim 2, where assigning the at least one string hypothesis to the entry in the lexical list is performed based on a substring of the at least one string hypothesis.

5. The method according to claim 2, where assigning the at least one string hypothesis to the entry in the lexical list is also based on a predetermined probability of mistaking the at least one string hypothesis with another string hypothesis.

6. The method according to claim 2, where assigning the at least one string hypothesis to the entry in the lexical list assigns a priority to the score.

7. The method according to claim 1, where comparing is performed when a predetermined condition is satisfied.

8. The method according to claim 7, where the predetermined condition is the at least one string hypothesis having a score greater than a predetermined value.

9. The method according to claim 1, where assigning scores to the at least two string hypotheses is based on an acoustic model probability.

10. The method according to claim 1, where assigning scores to the at least two string hypotheses uses a Hidden Markov Model.

11. The method according to claim 1, where assigning scores to the at least two string hypotheses is based on a grammar model probability.

12. The method according to claim 1, where digitizing the speech signal comprises dividing the speech signal into frames and determining for a feature vector for each frame.

13. The method according to claim 12, where the feature vector comprises spectral content of the speech signal.

14. The method according to claim 12, where the feature vector comprises a cepstral vector corresponding to the speech signal.

15. A system for recognizing speech using long lexical lists stored in a database, comprising:
a database that stores a lexical list;
an interface in communication with the database that detects a speech signal;
a processor in communication with the interface that digitizes the detected speech signal;
a recognition unit in communication with the processor that generates a plurality of string hypotheses corresponding to the speech signal and assigns a score to each of the plurality of string hypotheses;
a comparison unit that compares at least one of the plurality of string hypotheses with an entry in the lexical list based on the score of the at least one string hypothesis; and,
an assignment unit that assigns the at least one string hypothesis to the entry in the lexical list based on a comparison of the at least one string hypothesis with the entry in the at least one lexical list and the score of the at least one string hypothesis.

16. The system according claim 15, where the comparison unit is operable to perform comparison based on a substring of the at least one string hypothesis.

17. The system according to claim 15, where the assignment unit is operable to perform the assignment based on a substring of the at least one string hypothesis.

18. The system according to claim 15, where the assignment unit is operable to assign the at least one string hypothesis to the entry in the lexical list based on a probability of mistaking the at least one of the string hypothesis with another string hypothesis.

19. The system according to claim 15, where the assignment unit is operable to give a priority to the score of the at least one string hypothesis.

20. The system according to claim 15, where the comparison unit performs a comparison of the at least one string hypothesis with an entry in the lexical list when a predetermined condition occurs.

21. The system according to claim 16 where the predetermined condition comprises the at least one string hypothesis having a score greater than a predetermined value.

22. The system according to claim 15, where the recognition unit determines scores for the plurality of string hypotheses based on an acoustic probability.

23. The system according to claim 15, where the recognition unit determines scores for the plurality of string hypotheses using a Hidden Markov Model.

24. The system according to claim 15, where the recognition unit determines scores for the plurality of string hypotheses based on a grammar model probability.

25. The system according to claim 15, where the processor is programmed to determine a feature vector from the speech signal.

26. The system according to claim 25, where the feature vector comprises spectral content of the speech signal.

27. The system according to claim 25, where the feature vector comprises a cepstral vector corresponding to the speech signal.

28. A system for recognizing speech using long lexical lists stored in a database, comprising:
a database that stores a lexical list;
an interface in communication with the database that detects a speech signal;
a processor in communication with the interface that digitizes the detected speech signal;
means for generating a plurality of string hypotheses corresponding to the speech signal and for assigning a score to each of the plurality of string hypotheses;
means for comparing at least one of the plurality of string hypotheses with an entry in the lexical list based on the score of the at least one string hypothesis; and,
means for assigning the at least one string hypothesis to the entry in the lexical list based on a comparison of the at least one string hypothesis with the entry in the at least one lexical list and the score of the at least one string hypothesis.
